(19) United States
(12) Patent Application Publication
(10) Pub. No.: US 2005/0115753 A1
(43) Pub. Date: Jun. 2, 2005

(54) Automated vehicle steering and braking

(75) Inventors: Martin Pemberton, Bidford on Avon, Warwickshire (GB); Roger Aylward, Bidford on Avon (GB)

Correspondence Address: JOHN ALEXANDER GALBREATH, 2516 CHESTNUT WOODS CT, REISTERSTOWN, MD, 21136, US

(73) Assignee: Safeguard Technology Limited, Bidford on Avon, Warwickshire (GB)

(21) Appl. No.: 10/500,806

(22) PCT Filed: Jan. 9, 2003
(86) PCT No.: PCT/GB03/00054

(30) Foreign Application Priority Data
Jan. 11, 2002 (GB) 0200563.5

(51) Int. Cl. B62D 1/24

(52) U.S. Cl. 180/167

(57) ABSTRACT

A vehicle steering system, with multiple independent systems, employing different route referencing, such as a primary system (10), referring to a physical reference line (30), or multiple discrete markers; and a secondary system (20), referring to an independent reference store (18), expressed as a sequential instruction table, configured as an emergency backup, implemented upon failure of the primary system; the system allows coordinated vehicle steering and braking, for adherence to a prescribe route; multiple discrete route markers (66) allow route banding (62), and multiple routes (60A, 60B).

This invention relates to (route) navigation, guidance and control—and is particularly, but not exclusively, concerned with automated (road) vehicle steering and attendant automated route finding and following.

Some aspects of the invention are also concerned with:
multiple steering systems for redundancy and fail-safe backup; and
[emergency] vehicle braking—such as upon steering system failure.

A particular challenge is to preserve directional control under emergency braking, by addressing both braking and steering.

Terminology

The term ‘navigation’ is used herein to embrace determination of position, orientation or direction and routing.

In practice, navigation can be performed indirectly, by reference to an abstract inferential or representational map, chart, or frame of reference, positive identification of physical ground features, or radio reference beacon fixes and a prescribed route, or selection from a menu of alternative routes.

Broadly, navigation may be categorised as area navigation for air or sea passage where traffic might roam at will, aside from regulated airways or shipping lanes, or route navigation for land vehicles subject to route or terrain restraints.

Satellite GPS and ground based radio beacons are known for both area and route navigation.

In the highway passage art it is known to employ lane sensors for traffic to follow in disciplined succession.

The term ‘guidance’ is used herein to embrace (re-) directional prompting of (re-) orientation.

The term ‘steering’ is used herein to embrace physical pointing or assertion of direction.

As such, steering mechanisms include ground-engaging wheel, bogie mounted wheel set, skid or track runner articulation and/or selective or differential braking.

For convenience, the term ‘primary’ is used herein for one self-contained (steering) system and the term ‘secondary’ for another independent (steering) system.

That does not preclude role reversal or co-operative sharing of systems designated primary and secondary for the purposes of differentiation.

Automated Steering

Automated vehicle guidance and steering systems are known per se.

Similarly, automated emergency or progressive, cadence braking systems are known for rail vehicles—albeit where steering is not a consideration.

Numerous earlier proposals for automated road vehicle steering, area navigation and to follow traffic lane markings, include U.S. Pat. No. 6,059,063, U.S. Pat. No. 4,144,571, FR2684892, GB2374682, U.S. Pat. No. 5,708,427, US2001/0041953, U.S. Pat. No. 4,361,202, DE10117237, U.S. Pat. No. 6,081,187, FR2539888, U.S. Pat. No. 6,314,354, U.S. Pat. No. 4,656,406, U.S. Pat. No. 4996468, EP0788044, U.S. Pat. No. 5875408, U.S. Pat. No. 5,979,581, U.S. Pat. No. 6,259,980, U.S. Pat. No. 6,445,983, JP9146639, JP2001109520, US2001/0056544, etc

Backup

However, application of automated steering to passenger carrying public (transport) service vehicles (PSV's) requires meeting stringent safety standards, typically including a fail-safe, or default backup, steering facility.

Such a back-up typically requires a judicious combination of steering and braking, to slow and halt a vehicle, while maintaining a prescribed route.

A backup steering system should thus be able to keep the vehicle on course, for a set time or distance, at any point on the route, whether on a straight or sharp curve or bend, and regardless of instantaneous vehicle speed—or indeed route gradient or slope (downward or upward).

Urban Environment

Emergency considerations aside, for public transport vehicles to operate in a tightly confined, urban environment—typically congested with vehicular and pedestrian traffic—it is desirable that a vehicle strictly follows a designated route, identifiable by other traffic, whether or not a vehicle occupies the route.

Pedestrianised Route

It is also common to allow public transport vehicular traffic over so called pedestrianised, and thus otherwise largely traffic-free (aside from occasional emergency vehicles and deliveries at prescribed off-peak times) zones.

Similar considerations apply to more restricted private sites, such as roadways in theme parks, zoos, country house estates, etc.

Constrained Route

Imposed route constraints could require a vehicle to negotiate a much more tightly defined and laterally restricted route (in relation to vehicle size) than if, say, a driver had total freedom of movement.

Minor temporary local departure might be admitted for say collision avoidance, with a proximity (radar or ultrasonic beam) detector, but with long term departure precluded.

Predetermined Pathway or Route

To that end, it is known to provide a predetermined pathway over a prescribed route—relieving a vehicle driver or operator of the burden of steering, in favour of attention to (obstacle and pedestrian) hazard avoidance, essentially by braking.

Traditionally, a tramway or road form of railway, requires a dedicated route pathway, shared with, but enjoying priority over, other vehicles.

Limited Manoeuverability

A tram may have limited manoeuverability or freedom of manoeuvre, constrained to its prescribed pathway.

An overt visible or marked pathway—say, a painted surface line, or a differentially coloured surface, enables pedestrians or other vehicular traffic to be aware of potential conflicting tramway traffic.

A tram is generally accorded precedence over other vehicles, given its limited freedom of manoeuvre, if operating as intended by following a prescribed path.

Thus departure from an ‘expected’ path could create an even greater conflict hazard, requiring prompt recognition and remedial corrective (re)action.

A tramway need not rely upon bespoke track configured as guidance rails.

Rails entail a prohibitive capital installation expense not always justified and which would restrict tram adoption.

Thus, for a light urban tram, a route pathway may be contrived by other than a physical contact rail.

Remote Sensing

A diversity of pathways and attendant sensors may be adopted.

Thus a pathway may be a line marking upon the ground surface, with an optical on-board sensor.

Alternatively, the pathway may be a buried (electrical current-carrying) cable, used in conjunction with on-board electromagnetic field sensors.

Wayside route beacons can also play a part, as confirmatory position reference stations.

Such guidance systems are common in industrial environments for direction of robotic vehicles.

Moreover, aspects of positional control are known for certain industrial machine tools, to determine relative cutting tool and workpiece paths.

However, these are generally concerned with localised areas, that is generally within the immediate machine environment or confines, rather than protracted external, remote pathways.

Emergency Backup

With public transport vehicles, strict Health and Safety, Construction and Use, regulations apply—with considerations of robust, reliable and redundant systems design and configuration.

Fail-Safe

Thus another independent (secondary) system may be required as a fail-safe back-up to a (primary) steering system, such as a pathway sensor.

Should the vehicle sensor lose ‘track’ of the pathway, rather than simply activate an emergency stop procedure—which could prove hazardous to vehicle occupants—some emergency backup steering system would be advantageous.

Statement(s) of Invention

According to one aspect of the invention,
a vehicle steering system comprises
a route marker,
disposed along, or in close proximity to, a prescribed route,
and responsive to interrogation by a vehicle mounted sensor.

In practice, the marker may be configured as a continuous element, such as a cable, (flat) rail, strip, tape or band.

Alternatively, or indeed additionally, the marker may be configured as multiple discrete elements, such as (de minimis) metal studs.

Such a stud could be an inert metal pin or plate—recognisable by a vehicle metal detector within a certain downward looking or slant range.

However, some, albeit passive, (infrastructure) functionality can advantageously be incorporated into a marker.

Thus, for example, individual markers could comprise radio frequency (RF) identification (ID) tags.

Such RF_ID markers could have integral flash memory chips for read/write data storage.

Markers are readily installed by inserting or embedding in a roadway surface, with an underlying and/or peripheral locating anchor profile—and as such are robust and resistant to environmental factors, or surface debris.

Markers could supplement or be integrated within otherwise conventional reflective optical markers, known colloquially as ‘cats-eyes’.

Magnetised markers could exhibit a localised ‘field of influence’—allowing coding, by say polarisation, to reflect travel direction.

Markers could be disposed in a mutually staggered array—that is with a mutual lateral offset juxtaposition, to straddle a notional route centre line reference.

Combined or resultant influence field strength of neighbouring markers could be assessed by an on-board vehicle sensor, for route tracking.

Marker disposition and frequency could reflect route complexity and convolution—with, say, additional tags marking tight route curvature or bends.

A default minimum, of say, ¾ markers, in close proximity, could be imposed for a collective position fix, with an on-board vehicle arbitrator to mediate therebetween.

Marker functionality could include:
pre-program by passage of a reference vehicle over the route;
record vehicle ID and time of passage—accessible to later traffic for collision avoidance and transit history;
interrogation facility for accident investigation;
interrogation for productivity/performance assessment and maintenance regime;
service as wayside beacons with bolstered transmit radiation mode;
multiple alternative routing encoding, with tag clustering or grouping;
   Redundancy & Backup

The system may be configured with a measure of backup redundancy.

That is, more that a bare minimum of system functionality would be implemented.

Multiple independent systems could back-up one another or be combined.

Preferably, individual systems adopt different navigation principles.

Thus one system could refer to a reference line, representing a prescribed route; and another system could refer to an independent route reference store.

Operationally, such a route store could be expressed as a sequential instruction table.

One or other system could be configured as an emergency backup to the other.

Thus relative back-up roles could be reversed selectively.

Continuous Arbitration

A continuous comparison and arbitration could be made between the systems.

Primary & Secondary Systems

Alternatively, one system could be implemented only upon failure of the other—that is one treated as primary, the other as secondary.

Route Sub-division & Segmentation

More particularly, a prescribed route is sub-divided into sequential segments, each accorded a respective steering instruction, in relation to a preceding segment.

Route segments can be expressed as a plurality of successive way points, way point bearings, and [arcuate] paths,

Arc Curvature

Arcuate paths are defined about arc centres, laterally offset from a route centre line, as turning points.

A turn might be expressed as an arc of prescribed radius about a reference centre point.

Arcs may be regarded as convex (ie curved towards) or concave (ie curved away from) a centre point.

Similarly, directions along arcs can be defined as anti-clockwise or clockwise.

For the purposes of distinction, arcs can be assigned positive or negative ‘sense’ designations or signs.

Complex Curvature

Rather than purely circular arcs, and better to reflect route subtleties of form, more complex curves may be adopted.

Examples would include, (fragmentary) conic sections, such as ovals, hyperbola or parabola, or trigonometric functions, such as sine waves, requiring more elaborate geometric definition—such as with multiple reference points.

Mathematical curve generation—such as so-called Bezier functions—by interpolation between way points may be used.

Stepping Stones

Successive route segments can be referenced relatively or mutually, say as ‘stepping stones’ from one segment to another.

Active Guidance

Aside from the ‘passive guidance’ approach of markers or route stores, a more (pro)active guidance may be employed—an example being area navigation cover.

Area Coverage

Area navigation could use remote or wayside beacons, with transmission radiation power to suit.

Established cell-phone and/or satellite telecommunications networks, including GPS, could be used.

This area cover could provide one reference, for comparison with, or back-up by or to, route markers and stores.

Reference Beacons

A comparative or joint multiple (say, dual) mode system could avoid large accumulated errors in any individual system, by taking into account supplementary ‘downstream’ confirmatory reference points, such as radio beacons, or wayside triggers.

Preview Mode

Smooth and progressive steering requires some knowledge-based anticipation or preview of the route ahead, enabling a pro-active, rather than merely belated reactive, steering (input) action.

This is particularly so for strict adherence to a well defined route, with minimal departure tolerance.

A driver can look ahead and subconsciously mentally prepare, but if distracted, driver actions can become overly retrospective, post-corrective and disjointed.

Certain aspects of the invention relate variously to automated steering, backup steering and preview steering action or operational modes.

### EMBODIMENTS

There now follows a description of some particular embodiments of a vehicle emergency steering and braking system according to the invention, by way of example only, with reference to the accompanying diagrammatic and schematic drawings, in which:

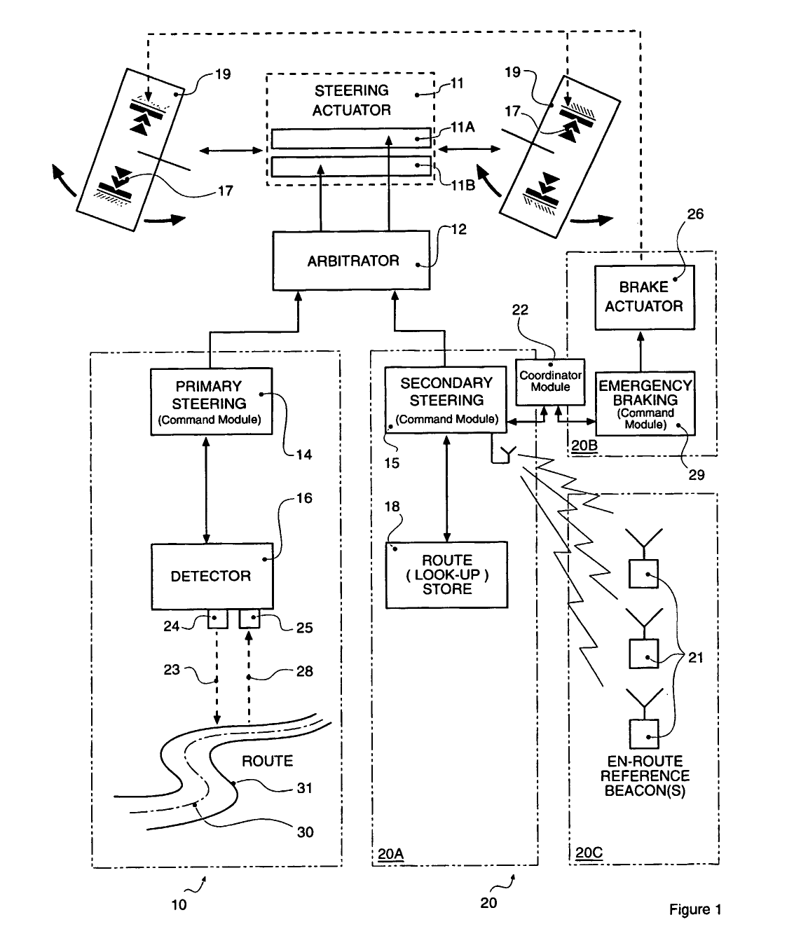

FIG. 1 shows a block schematic layout of principal elements of a primary steering system with parallel secondary or emergency backup steering and braking systems;

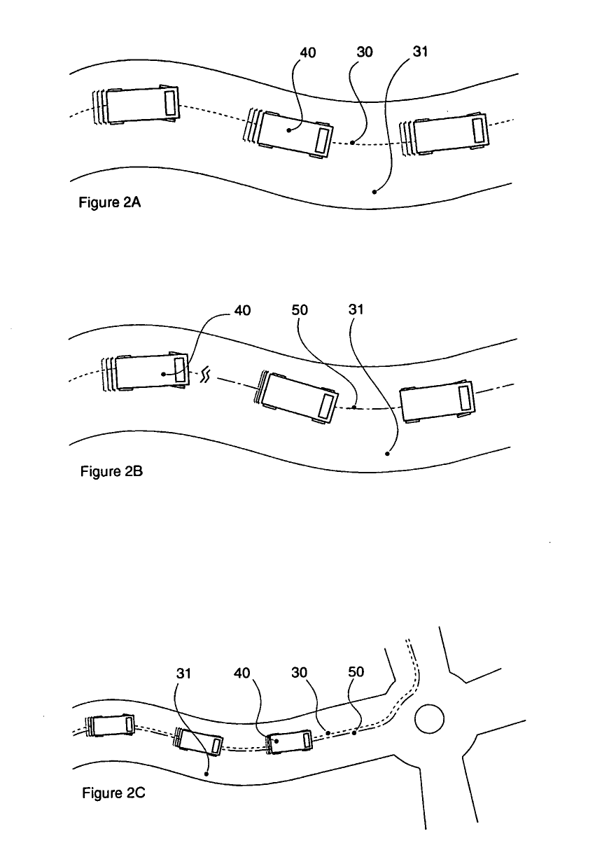

FIGS. 2A through 2C show operation of the secondary or emergency steering (and braking) system of FIG. 1, under automatic guidance system failure, and ‘normal’ driving under automated guidance control.

More specifically:

FIG. 2A shows a vehicle under automatic guidance system control, travelling along a guideway during ‘normal’ driving;

FIG. 2B shows the same vehicle, upon failure of the automatic guidance system, being brought safely to a halt by a secondary guidance system according to the invention; and

FIG. 2C shows how the emergency steering system can be used to assist the automatic guidance system to enhance ‘normal’ driving performance;

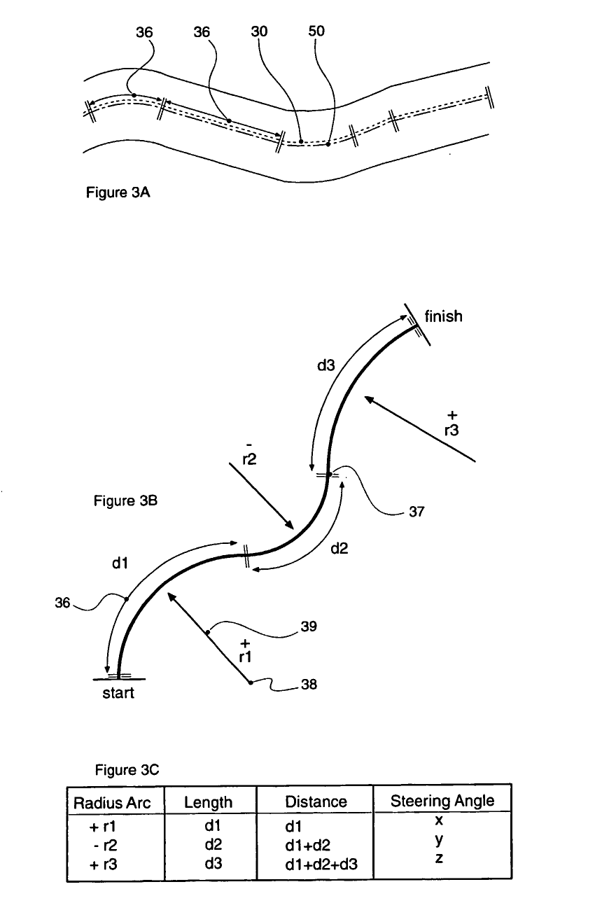

FIGS. 3A through 3C show route analysis by segmentation for the secondary steering system of FIGS. 1 and 2B/2C;

More specifically:

FIG. 3A shows a route segmentation in straight and curved segments;

FIG. 3B shows a mathematical abstraction of the route of FIG. 3A, with nominal plus or minus signs accorded respectively to clockwise or anti-clockwise arc transit direction or orientation;

FIG. 3C shows a tabulated analysis of route segments, expressed as a sequentially stacked look-up table of definitive segment factors, such as arc radius, length and attendant vehicle steering angle;

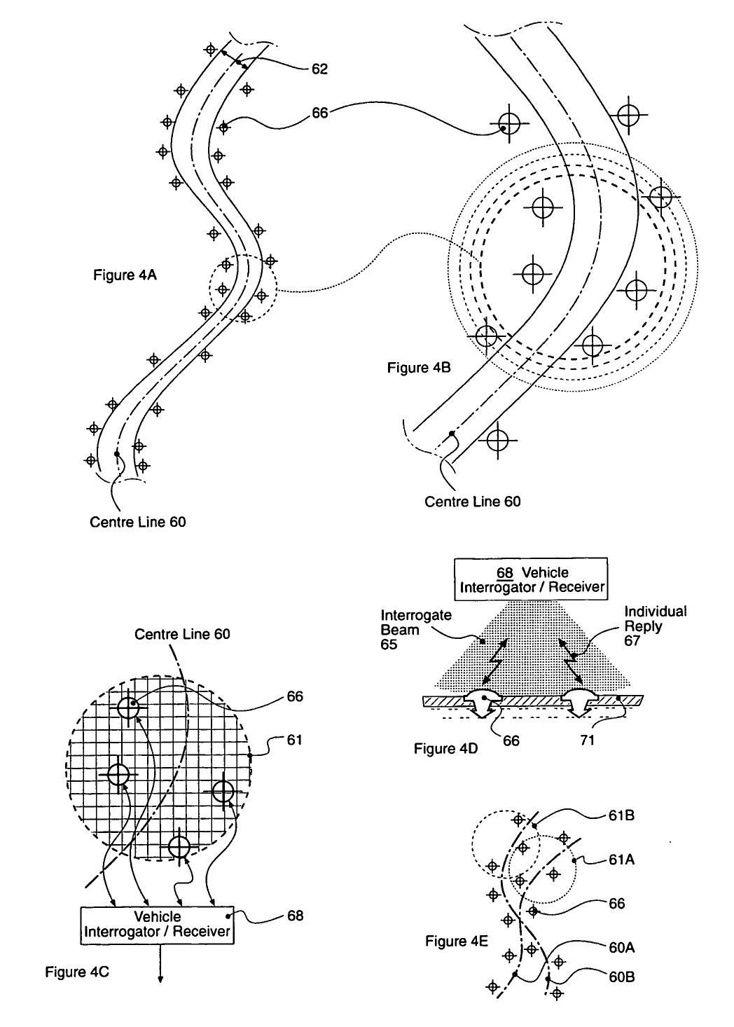

FIGS. 4A through 4E depict a system of prescribed route line determination by successive discrete markers—allowing multiple routes;

More specifically:

FIG. 4A shows a plan schematic of a curvaceous route of varying width or span, delineated by multiple discrete individual markers;

FIG. 4B shows an enlargement of part of the route, and clustering of individual markers at key route transitions;

FIG. 4C shows a sphere of influence of clustered markers of FIG. 4B under joint interrogation and individual reply from an on-board vehicle interrogator/receiver transducer;

FIG. 4D shows a part sectioned side view of simultaneous interrogation and individual response from markers submerged into a roadway surface over a prescribed beam width or spread;

FIG. 4E depicts multiple routes defined by respective sub-set clusters or groupings of a common overall marker array.

Referring to the drawings, a (road) vehicle 40, such as a bus or tram, has an automated steering system—to track a prescribed route, within certain error bounds.

Vehicle progress along the route—vis speed and braking—could also be automated, albeit this example exhibits only an automated emergency breaking facility.

More specifically, multiple—in this case dual—independent steering systems, allow a fail-safe backup and mutual cross-referencing for accuracy and reliability.

For convenience in differentiation, the systems are respectively designated primary and secondary 20—for directing respective steering actuator modules 11 A, 11 B, in turn coupled to vehicle steered wheels 19.

Alternatively, the primary and secondary steering systems 10, 20 are allocated a common or integrated actuator 11.

In the case of a tram, the steered wheels 19 may be configured as a steerable bogie mounted wheel set, and the actuator(s) operative accordingly.

The terms primary and secondary need not represent a hierarchy of importance, reliability or precision, but rather simply differentiate one system from another.

Roles of primary and secondary systems could be reversed or combined, with integration of emergency braking intervention adapted accordingly.

‘Primary’ [One] Steering System

One (primary) steering system 10 tracks a route reference designator line 30, with a physical presence—such as a continuous physical marker—of a buried electrical cable, flat guide rail, strip, tape, band or optical surface marking—along a route 31.

FIGS. 4A through 4E depict an alternative route designation through successive discrete marker tags, as discussed later.

A detector module 16 detects departure of the vehicle 40 from that reference line 30.

In this example, a detector module 16 is coupled to a transmitter head 24, generating an output beam 23, and a receiver head 25 for a return beam 28.

This could represent an optical beam sensor and/or magnetic (flux) field detection arrangement for a ‘passive’ route delineation upon a roadway surface.

Whilst shown separately for clarity, transmitter and receiver heads may be combined—as with a common aerial or magnetometer flux coupler.

In the case of a buried, current-carrying reference cable, which actively radiates electromagnetic waves, a receiver head only is required.

Departure from the route—beyond prescribed tolerances—is recognised by the detector 16, which generates an error signal, fed to a primary steering command module 14, for interpretation and issue of an appropriate corrective (return-to-track) signal direction for the respective steering actuator module 11 A.

Allowance may be made for control lag, roadway surface condition, speed and vehicle occupancy comfort, to dampen out undue lateral acceleration through over-abrupt steering correction.

‘Secondary’ [Another] Steering System

Another, independent ‘secondary’ steering system 20 comprises an intercoupled:
steering facility 20A;
emergency braking facility 20B; and
en-route radio beacon reference facility 20C.

In this example, the secondary steering system 20 is configured as an emergency back-up to the primary system 10 and so operates on a different principle.

Again, the roles of primary and secondary systems may be reversed, or inter-coupled, to contrive a balanced interpolated or arbitrated steering direction.

In the secondary system, reliance is not placed upon the physical route track reference line 30, but rather a notional ‘abstraction’ of it, indicated by chained route (centre) line 50 in FIGS. 2B and 2C.

This notional route line 50 is an independent route referral source, expressed in terms of a sequential incremental instruction catalogue—such as encapsulated in FIGS. 3B & 3C.

In practice, route line 50 may be a wide tolerance band, and the attendant instructions adapted accordingly, say to convey value maxima and minima.

FIGS. 4A through 4E explore such route banding.

More specifically, as depicted in FIGS. 3A & 3B, a required route 31 is sub-divided, 35 by careful analysis, into a sequence of compact ‘manageable’ segments 36, for progress monitoring and (instruction) control.

Each segment 36 is defined by a bounding length and a curvature.

Curvature dictates a steering angle setting for the steering actuator 11.

That said, operationally, steering angle may also reflect steering geometry, vehicle suspension loading and speed.

Curvature is expressed as a radius 39 of a (nominally) circular arc, inscribed about an arc centre 38.

Arithmetic ‘qualifier’ or ‘operator’ plus (or positive) and minus (or negative) signs are assigned according to arc orientation or direction with respect to an arc centre point—vis clockwise or anti-clockwise, to ensure appropriate steering direction.

Arc centre position 38 can be defined in relation to an associated segment 36 start or end point 37.

Some segments 36 are straight (ie no curvature) and some curved.

The length or vehicle duration (time scale) of each segment 36 reflects operational considerations.

Thus, for example, such diverse factors as route complexity (vis how straight, or convoluted), anticipated transit speed, en route hazards, and braking performance, admit consideration.

The resolution or detail of segments 36 matches, or is compatible with, the precision of the (direct sensory reference) primary steering system 10.

Precision can be supplemented, or cross-checked, with ancillary en route references, such as wayside (radio) beacons 21, of the en-route facility 20C, in order to avoid progressive error accumulation.

Thus a positive (low power) radio beacon local passage or transit, or triangulation fix of multiple (higher power) beacons can re-set the current segment 36 and the position thereupon.

A route (look-up) store or memory 18 is pre-loaded with a so-called ‘look-up’ table, of such sequential incremental route progress segments 36, such as set out in tabulated format in FIG. 3C.

Progress is monitored independently with reference to the route store data 18.

This secondary system 20 monitoring is thus a backup to the primary system 10 and its own attendant monitoring and control.

Emergency Braking

The secondary steering system is coupled to an emergency braking facility 20B, comprising an emergency braking command module 29 and a brake actuator 26, coupled to a brake mechanism 17 in each vehicle wheel 19.

A coordinator module 22 links the emergency steering facility 20A with the emergency braking facility 20B.

Co-ordination may also be with the other (primary) steering system 10.

‘Primary’ Steering System Failure

Generally, no initiative is taken by the secondary system 20A, to direct vehicle steering—or counteract or over-ride the primary system 10, unless and until a (major) failure of the primary system 10 arises and is recognised.

Such recognition may be triggered by the primary detector 16, the primary steering command module 14, or the secondary steering command module 15 recognising a departure from instructions prescribing the route abstraction 50.

Otherwise, there would be a risk of the primary and secondary steering systems 10, operating continually in conflict or ‘competition’, with possible contradictory corrective directions and response misinterpretation.

A major failure might be the primary system 10 losing track altogether of the physical reference line.

This might be expressed as a detector 16 signal loss, say through a departure from the reference line 30 beyond the detector range (say, a loss of detector return signal 28), or some errant detector 16 output signal or system failure.

Absent some retrieval of position provision, the vehicle represents a traffic hazard.

In order to address this, upon recognising a primary system 10 failure, the emergency steering system 20 intervenes to:
preserve directional control through steering action; and
apply (progressive) vehicle braking, as deemed necessary.

If the vehicle position is judged hazardous—say in a region of intense traffic flow—the emergency steering system 20 intervention could continue until the vehicle is in calmer conditions—that emergency braking is suspended.

In more sophisticated variants, such as of FIGS. 4A through 4E, a default parked position might be stored for each route centre line position—and to which a failed vehicle could be safely brought to a halt.

For ongoing steering direction, the secondary system 20 relies upon its route reference source 18.

That is, by access to the look-up table in the route store 18, the secondary system 20 ‘knows’ the past, immediate present and future route segments 36.

The secondary steering command module 15, duly primed by the route store 18, can direct the vehicle steering actuator 11 accordingly.

In order to obviate conflict, or ‘competitive direction’ of the steering actuator 11 (modules 11A, 11B) by the primary steering system, the primary system 10 can be disabled, or at least uncoupled from the respective steering actuator module 11A.

This can be achieved with an arbitrator module 12, to which both the steering command outputs of the primary steering module 14 and secondary steering module 15, are applied.

The arbitrator 12 thus determines whether the primary or secondary steering systems 10, 20 directs the common steering actuator 11.

Interpolation

Rather than simply elect one and reject the other, the arbitrator 12 could ‘blend’ or ‘merge’ (eg interpolate) steering outputs from the primary and secondary steering command modules 14, 15 respectively.

This is elaborated upon later, under the heading ‘Route Preview Mode’.

Generally, the route store 18 could be loaded with multiple alternative routes and adapted for different vehicle steering and braking performance.

Routes and vehicle modes could be software selectable, with provision for route update, sub-division and combination to meet changed journey circumstances.

Route (up and down) gradients, camber (side slope) and surface condition (wet, icy or dry) ‘weighting’ could also be addressed as steering and braking stability considerations.

Route Preview Mode

The sensor 25 of the primary steering system 10 detector module 16 is essentially local to the vehicle and short range ‘downward’ looking at the immediately underlying, or marginally ahead, route line 30.

Thus the primary steering system 10 is essentially ‘reactive’, reflecting past and present vehicle position, in response to a local route segment 36—and so could benefit from some ‘anticipatory’ or preview facility.

Advance route knowledge available from the route store 18 could contribute to just such a preview.

A longer range forward detector scan might also be employed, in the manner of following ‘cats eyes’, or white line lane marking, by optical sighting.

It is envisaged that supplementary steering direction input from a route preview could enhance steering performance in ‘normal’ driving mode, otherwise supervised by the primary steering system 10.

In practice, preview direction could be achieved by feeding stored preview route knowledge interpreted by the secondary steering system 20, to the respective steering actuators 11A, 11B.

This might be termed steering ‘cross-coupling’—implemented by joint (consistent) commands to the arbitrator module 12.

Indeed, preview control direction—implemented as an instruction ‘overlay’—could reduce, but not necessarily pre-empt, raw ‘re-active’ direction from the primary steering system 10.

Generally, the vehicle would be less likely to make radical excursions from the route line 30, with the benefit of a preview of its future path.

Preview insight could be used in conjunction with a speed limiter module (not shown).

Thus, a modest increase in vehicle speed could be admitted when route conditions allow, such as over a straight route segment

Conversely, when the vehicle approaches a known route hazard, such as a bend or junction, a decrease in speed can be effected by disabling of an accelerator and/or pre-application of the brake actuator, for negotiating the hazard.

Journey comfort for passengers could be enhanced through smoother and more progressive vehicle direction and handling.

Moreover, journey times could be reduced by judicious use of vehicle speed, without abrupt transitions.

The flexibility of the system is such as to accommodate ancillary sub-routes, or departures from the primary route, in emergency situations.

Thus, say, each route segment or segment cluster, representing the normal route could be allied with a ‘run-off’ sub-route, to allow a vehicle to be brought to a kerb side—rather then left stranded in the middle of a highway or thoroughfare.

This option assumes such departure would be safe—not least in relation to the expectations of other road users.

Route and braking can be changed to reflect vehicle loading and route conditions (even visibility), such as a fully laden vehicle in slippery conditions.

Multiple Vehicles

Although the system has been described in relation to an individual vehicle, it is applicable in principle to multiple individual vehicles upon a common track 30.

Communication between vehicles 40, progressing in tandem upon a common route 30, could be through, say, a buried electrical route cable or radio.

The supplementary radio beacon reference facility 20C could be used to communicate between vehicles 40.

Individual and relative vehicle speeds could be adjusted accordingly, in order to preserve even vehicle spacing and avoid bunching—thus spreading the route traffic capacity more evenly.

Collision risks could also be reduced for vehicles 40 in close queued proximity.

Reference Index Markers

Sophistication of route abstraction, and in particular a route centre line 60 could embrace multiple successive discrete route markers or marker tags.

Such markers could be ‘passive’, such as individual metal studs, or incorporate some functionality, to allow data storage, remote interrogation and update.

That said, a potential ‘active’ marker role is envisaged, as discussed later.

Markers need not literally follow a route centre line 60, but can be displaced to allow a collective centre line fix by joint interrogation of grouped markers in the same vicinity.

This would facilitate route (width) banding 62 and route adjustment according to circumstances.

Thus multiple juxtaposed or intersecting routes 60A, 60B could be contrived by judicious use of some or the whole of a common marker set 66.

One approach is so-called Radio Frequency Identification (RF-ID), with re-writable flash memory chips accessed to monitor passing vehicle traffic and log traffic history.

As indicated in the previous Statements of Invention, route marker tag functionality could include:
pre-program by passage of a reference vehicle over the route; this could represent data loading and enabling to preface a current routing;
record vehicle ID and time of passage—accessible to later traffic for collision avoidance and transit history; a portion of available marker memory could be allocated to long term reference—only erased upon deliberate coded action;
interrogation facility for accident investigation; either long or short term data could be reviewed, say for evidence of vehicle traffic patterns;
interrogation for productivity/performance assessment and maintenance regime; thus routing could be adjusted by learning from experience;
service as wayside beacons with bolstered transmit radiation mode; markers could radiate transmission over a wider range; thus markers could communicate with one another, vehicles in transit, and a base station;
multiple alternative routing encoding, with tag clustering or grouping; an efficient way of route adaptation without having to relocate or install new markers.

Markers could signal the proximity of the next vehicle to waiting passengers at wayside halts or stops.

Moreover, through remote senders located at wayside halts, or indeed free-roaming transponders issued to them, passengers could send waiting signals to the marker chain to trigger an on-board vehicle notification and demand priority attention.

Vehicles might thus be flagged down on demand, with an authority key code.

Enhanced routing functionality is explored in FIGS. 4A through 4E, in the context of multiple discrete markers.

For ease of reference, FIGS. 4A through 4D depict a single notional route centre line 60, but the principles apply to multiple alternative (or simultaneous) routes 60A, 60B, etc, as depicted in FIG. 4E.

FIG. 4A shows a route centre line 60, with a route band, lateral span or width 62 ‘defined’ by successive multiple individual markers 66.

Route band could be wider or narrower than marker 66 spacing, by encoding marker response to interrogation by an on-board vehicle transponder.

Router markers are shown in side section in FIG. 4D, in this example configured as ground studs, with integrated internal solid-state electronic functionality.

Markers 66 need not necessarily lie physically on a particular route centre line 60, but can be mutually laterally offset in relation thereto, and to one another.

The markers are grouped or juxtaposed in common local ‘spheres of influence’, or (coded) range sectors, represented by cross-hatched area or cell 61 in FIG. 4C.

A common interrogation beam 65 from an on-board vehicle data capture module 68, combining transducers for transmission and reception, triggers individual replies 67 from respective markers 66, allowing separate and collective interpretation.

The unique sphere of influence 61 or cell of a given marker 66 group or cluster is permeated by a unique notional route centre line 60(A).

Addition or omission of markers would create another cell 61, defining an alternative route 60(B), as depicted in FIG. 4E.

Generally, a minimum of, say, ¾ individual markers 66 would collectively achieve a given unique combination and identity fix.

A different marker 66 grouping would have a different sphere of influence ‘signature’.

Individual markers 66 may adopt disparate forms, but are conveniently configured as ground locating and anchoring spikes, resisting inadvertent withdrawal after insertion, as depicted in FIG. 4D.

Marker heads may be slightly proud of, or submerged somewhat beneath, a roadway surface 71.

The heads could incorporate optically reflective elements, for visual sighting, as a vehicle operator cross-check or for ease of identification in maintenance and repair.

In practice, continuous (eg cable or strips) and discrete (eg studs) route marking or delineation may be combined, or used interchangeability, according to route and traffic circumstances.

Thus, for example, in the manner of a railway track, continuous linear segments may be laid as unequivocal delineation of route intersections, junctions or interchanges, where routes are in close proximity or overlap—with discrete individual markers to delineate more isolated individual route runs therebetween.

Component List

10 primary steering system
11 steering actuator
11A module
11B module
12 arbitrator
14 primary steering command module
15 secondary steering command module
16 detector module
17 brake actuator
18 route (look-up) store
19 vehicle wheel
20 secondary steering system
20A steering facility
20B emergency braking facility
35 20C radio beacon reference facility
21 radio beacons
22 coordinator module
23 output beam
24 transmitter head
25 receiver head/sensor
26 brake actuator
28 return beam
29 emergency braking command module
30 route line
31 pathway/route
36 route segment
37 route way point
38 arc centre
39 arc radius
40 vehicle
50 notional route
60 (notional) route centre line (alternatives 60A, 60B)
61 sphere of influence/cell (alternatives 61A, 61B)
62 route band
65 interrogation beam
66 marker
67 individual reply
68 on-board vehicle data capture module—interrogator/receiver transducers
71 roadway surface

1. A vehicle steering or guidance system,
comprising a route marker,
disposed along, or in proximity to, a prescribed route,
and responsive to interrogation by a vehicle mounted transducer,
to provide vehicle route guidance and steering direction.

2. A vehicle steering system, as claimed in claim 1,
with a route marker configured to respond to interrogation by, say, relay of route and/or traffic data.

3. A vehicle steering system, as claimed in claim 1,
with a route marker configured as a continuous element, such as a cable, (flat) rail, strip, tape or band.

4. A vehicle steering system, as claimed in claim 1,
with a route marker configured as multiple discrete elements,
laid in succession and mutually juxtaposed in relation to one another,
and one or more prescribed routes.

5. A vehicle steering system, as claimed in claim 1,
with a combination of continuous and discrete route markers.

6. A vehicle steering system, as claimed in claim 1,
with one or more notional continuous route pathways,
defined by multiple discrete pathway markers or marker beacons.

7. A vehicle steering system, as claimed in claim 1,
wherein individual markers comprise radio frequency (RF) identification (ID) tags,
with integral flash memory chips for read/write data storage.

8. A vehicle steering system, as claimed in claim 1,
wherein markers supplement, or are integrated within,
otherwise conventional reflective optical markers, such as ‘cats-eyes’.

9. A vehicle steering system, as claimed in claim 1,
with route markers configured as magnetised identification tags,
with a localised ‘field of influence’,
allowing coding, by say polarisation, to reflect travel direction.

10. A vehicle steering system, as claimed in claim 1,
with route markers disposed in a mutually staggered array,
that is with a lateral offset to straddle a notional route centre line reference.

11. A vehicle steering system, as claimed in claim 1,
with multiple individual route markers configured for collective response,
in groups or cells defining a common sphere on influence.

12. A vehicle steering system, as claimed in claim 1,
with multiple individual route marker disposition and frequency reflecting route complexity and convolution,
with, additional markers at tight route curvature or bends.

13. A vehicle steering system, as claimed claim 1,
with a default minimum, of say, ¾ discrete route markers, in close proximity,
imposed for a collective position fix,
with an on-board vehicle arbitrator to mediate therebetween.

14. A vehicle steering system, as claimed in claim 1,
wherein route marker functionality includes some or all of:
a) pre-program by passage of a reference vehicle over the route;
b) record vehicle ID and time of passage—accessible to later traffic for collision avoidance and transit history;
c) interrogation facility for accident investigation;
d) interrogation for productivity/performance assessment and maintenance regime;
e) service as wayside beacons with bolstered transmit radiation mode;
f) selective grouping for route banding and multiple routing.

15. A vehicle steering system, as claimed in claim 1,
configured with backup redundancy,
through multiple independent steering systems.

16. A vehicle steering system, as claimed in claim 1,
with a facility for triggering emergency vehicle braking,
upon steering system failure.

17. An automated vehicle steering system,
comprising a primary module (10),
referring to a physical reference line (30),
or multiple discrete route markers (66);
and a secondary module (20),
referring to an independent reference store (18),
expressed as a sequential instruction table,
configured as an emergency backup,
implemented upon failure of the primary module.

18. A vehicle steering system, as claimed in claim 1,
wherein a prescribed route (50) is subdivided,
into sequential segments (36),
each accorded a respective steering instruction,
in relation to a preceding segment.

19. A vehicle steering or guidance system,
comprising
a vehicle mounted transducer,
configured to interrogate one or more route markers,
disposed along, or in proximity to, a prescribed route,
and responsive to marker reply to such interrogation,
by providing vehicle route guidance and steering direction,
to a steering actuator.

20. (canceled)

21. A vehicle incorporating a steering system, as claimed in claim 2.

22. An emergency combined steering and braking system, for a (road) vehicle,
using accumulated sequential pre-stored route data,
to determine current position and future steering action,
in order to follow a prescribed route,
and, in emergency circumstances, to trigger braking action,
consistent with vehicle route speed and onward route profile,
and thereby to bring the vehicle safely to a halt,
while preserving directional control,
and adherence to the prescribed route.
